(19) United States
(12) Patent Application Publication
(10) Pub. No.: US 2020/0183531 A1
(43) Pub. Date: Jun. 11, 2020

(54) TOUCHSCREEN KEYBOARD SYSTEM

(71) Applicant: Bennet Karl Langlotz, Dallas, TX (US)

(72) Inventor: Bennet Karl Langlotz, Dallas, TX (US)

(21) Appl. No.: 16/215,768

(22) Filed: Dec. 11, 2018

(51) Int. Cl. G06F 3/041; G06F 3/0488

(52) U.S. Cl. CPC G06F 3/0418; G06F 3/04886

(57) ABSTRACT

A touchscreen keyboard system is provided for operating a smart device having a touch screen. The system comprises an array of key elements, which can generate a map of touch sensitive areas, each corresponding to a respective key element. The touchscreen keyboard system detects error correction activity and based on detecting an error correction activity, it will modify the map.

### FIELD OF THE INVENTION

This invention relates to virtual keyboards such as are displayed on smart phones and portable tablet devices.

### BACKGROUND OF THE INVENTION

To provide a large viewing area, smart phones and tablets have touch-sensitive screens that extend across substantially their entire surfaces. When keyboard entry is needed, part of the screen is used to display a keyboard, and the touch screen employs a map to generate entry of characters based on the section of the map that receives a touch contact.

With screens of limited size, the keyboards tend to be smaller than desired, leading to occasional and potentially frequent typing errors. To minimize the effect, the devices rely in part on spell correction to infer the intended word from the entered characters, occasionally leading to awkward errors.

In general, large and hurried fingers, small keys that are hidden by the fingers lead to some types of errors that may be characterized as “random” in that they are as likely to be errant in any particular direction.

However, in existing systems, a typical user may find that certain typing errors recur. For example, a user may find that instead of reaching far enough to select the central “space-bar” he occasionally errantly contacts the more peripheral “return” key, rarely if ever making the reverse error. Or a user may have any other predictable bias, striking certain keys on average off center in a selected direction.

There is a need to avoid such predictable errors patterns to reduce overall errors.

The limitations of the prior art are addressed by providing a touchscreen keyboard system for operating a smart device having a touch screen. The system comprises an array of key elements which can generate a map of touch sensitive areas, each corresponding to a respective key element. The touchscreen keyboard system detects error correction activity and based on detecting error correction activity, it will modify the map.

### BRIEF DESCRIPTION OF THE DRAWINGS

FIG. 1 shows a screen display of a smart device.

FIG. 2A shows a device screen image with a single touch grid modification.

FIG. 2B shows an alternative embodiment of a device screen image.

FIG. 3 illustrates an enlarged keyboard to reduce keystroke errors.

FIG. 4 illustrates an enlarged display on a device screen.

FIG. 5 is a graphical representation of two populations of keystrokes.

FIG. 6 illustrates an enlarged display on a device screen.

### DETAILED DESCRIPTION

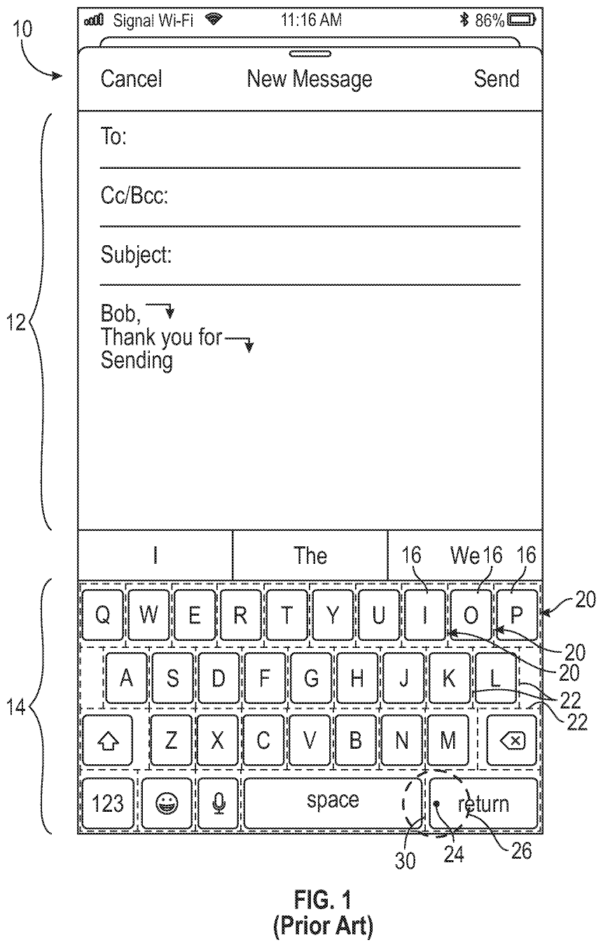

FIG. 1 shows a prior art screen display 10 of a smart device. It includes a typing display area 12 and a virtual keypad 14. The device has a display depicting an array of keys 16 behind a transparent touch sensitive window that is mapped with corresponding touch areas 20. The touch areas are separated into an array or touch grid that is registered with the displayed key images, with the boundaries 22 of the touch grid being aligned with the boundaries between the key images. Thus, any finger touch in the area of any key image will generate a corresponding signal to the device controller that the associated key is desired for entry. Touches near boundaries 22 will be assigned to the nearer key image without bias.

In the display area 12, a user has typed a message, and after the word “for has inadvertently touched the area of the “return” key image instead of the intended spacebar. This is indicated with touch center-point 24 and circular area of contact 26. Whether a device detect the first point of contact or infers a center point from an area of contact, the result is the same. As shown, the selected point is just to the right of the boundary segment 30 that separates the touch areas for the spacebar and the return key.

Typographic errors with small smart device touchscreens may have a number of sources. Some may be errors of user intent, “aiming” for the wrong letter. Others may be simple imprecision in which intentions are correct, but there is significant random or unbiased error in which aim is poor but in no particular direction. These are generally addressed with practice and care.

A second type of error occurs repeatedly, and may be specific to an individual, or a type shared by many or most individuals. This is a general bias. A typical bias is for a user who cradles a device in the fingers of each hand, and operated the keyboard with thumbs extending laterally inward and upward, each thumb covering its right or left half of the keyboard. In this example, many users may tend to find that their thumbs didn't reach far enough, and fell short from the intended key and struck laterally away from the intended key. This may be due to a psychological subconscious expectation that the tips of the thumbs are the making contact with the keys (when it is the pad of the thumb, some distance from the tip). Or it may be because users desire to see the key they are striking, and extending the thumbs far enough medially blocks the view of the desired key creating a reluctance to fully extend medially.

For an individual, repeated errors may occur due to physiological limitations or imbalanced thumb or finger shapes, or for any other reason particular to the user.

To reduce the frustrations and inefficiencies of typing errors caused by predictable tendencies, such as the “short thumb” syndrome described above, and touch grid or map may be developed that is offset from the apparent key locations. This can be set to minimize typing errors either for a population or for a user. There may be “types” of users that have certain errors other than “short thumb” types, and there may be several standard maps developed, one for each type.

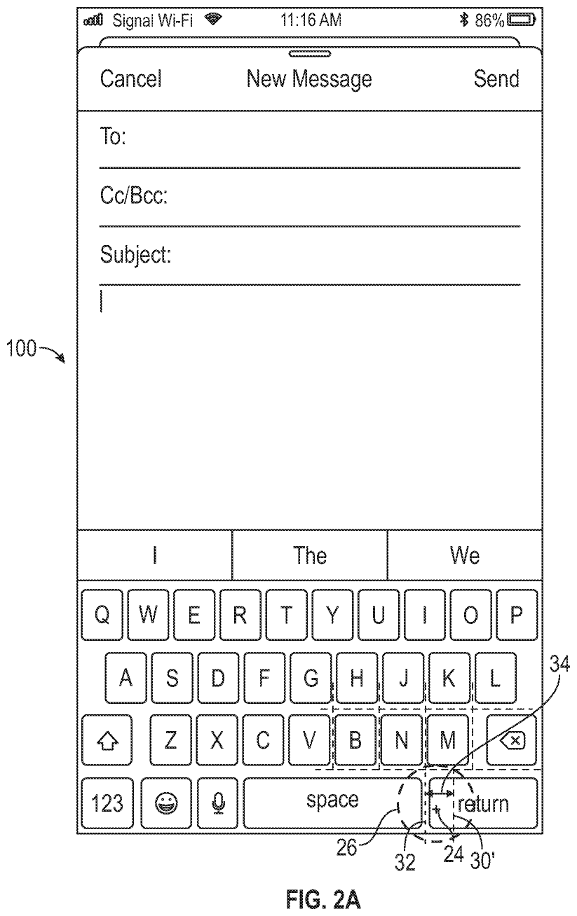

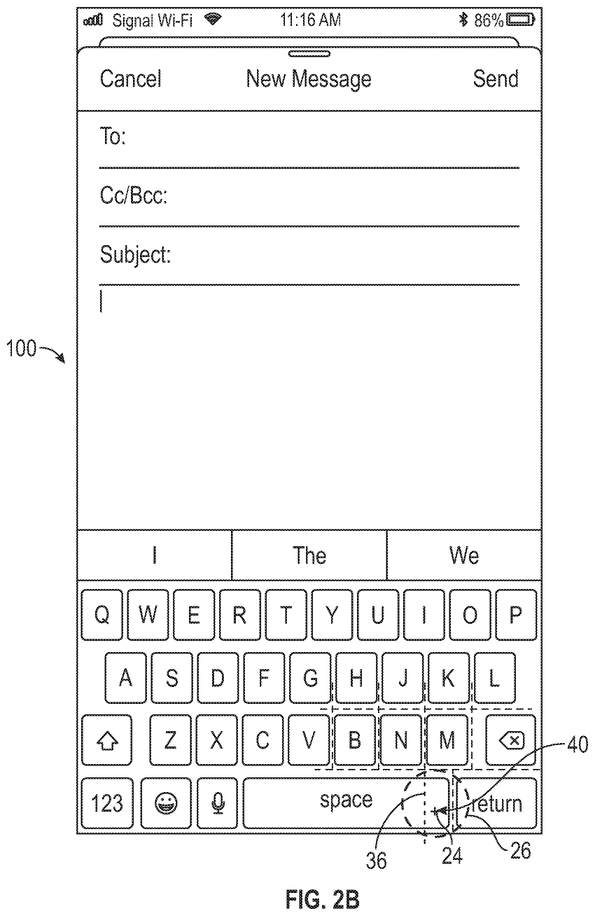

FIG. 2A shows a device screen image 100 with a single touch grid modification to illustrate how a “short thumb” user who tends to hit the “return” key instead of the spacebar as shown in FIG. 1. The touch grid boundary line 30′ dividing the touch areas for spacebar and return is shifted right from the apparent visual boundary 32 between these two keys. In this case the shift is by a distance 34 in a lateral direction away from the middle of the device. As a result of the shifted touch grid boundary, the center-point 24 of the user's touch intended to be a space is now on the space side of the line, and correctly registered as intended.

In an alternative embodiment shown in FIG. 2B, the keys' apparent visible boundaries may be shifted along with the grid map boundaries from the original line 36 to a new location 40 for the simple benefit to help those who prefer certain keys of certain size or location, but for users with the visual/tactile shift or bias this may simply shift the problem without solving it. It may prove that a combination of some keyboard image change is desired with a further shift of the touch grid map from the adjusted apparent key boundaries.

FIG. 2A illustrates one grid map shift to address one keystroke problem. In the preferred embodiment shifts may occur all over the keyboard, both vertically and horizontally as will be illustrated below, and the grid may have curved lines with keys of different shapes.

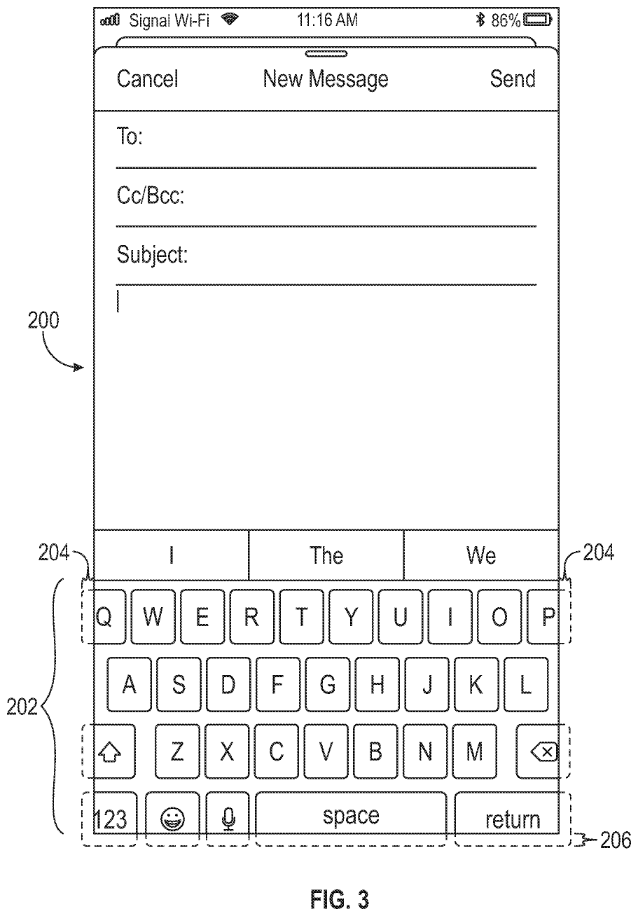

FIG. 3 shows an additional approach to generally reduce keystroke errors by effectively enlarging the keyboard. The display area 200 is normal, except that the keypad area 202 is enlarged to bleed the peripheral keys partially off the apparent edges. Thus, keys on the side edges have their lateral portions 204 cut off, and keys on the bottom edge have their lower edges 206 cut off. While this reduces the area available for these truncated keys, the user may be unaffected because they can readily strike the edge of the touchscreen at the apparent center of the desired edge key without concern about the stroke being misunderstood. The benefit is that all the keys are slightly larger, perhaps by 10%, reducing all types of errors. This may be implemented without the benefit of the touch grid remapping, or combined with that feature for increased benefits.

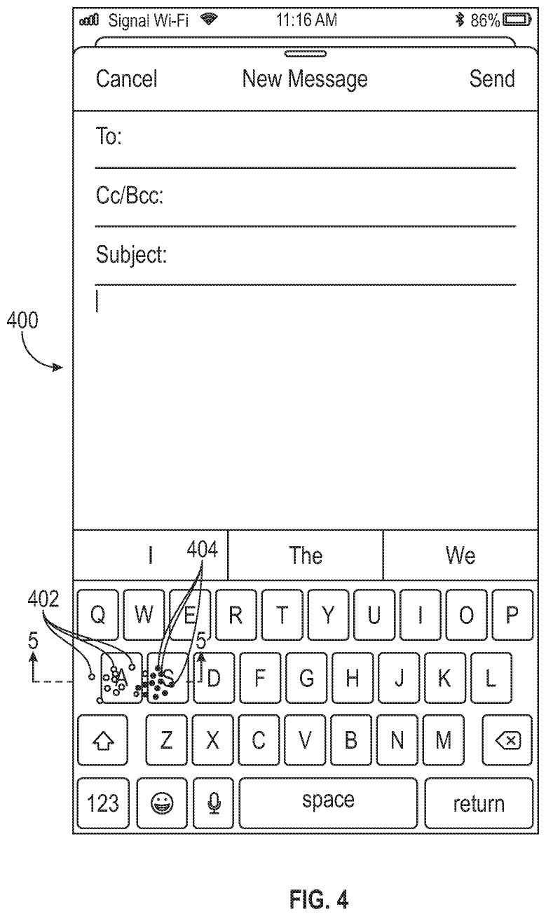

FIG. 4 illustrates display 400 showing a simplified recording of user keystrokes showing their actual locations. For simplicity, this illustrates keystrokes for adjacent keys “A” and “S”. The A strokes are shown with open circular dots 402 and the S strokes are illustrated with solid dots. It is apparent that the cluster of dots for each key is below and to the left (lateral) of the center point of each displayed key.

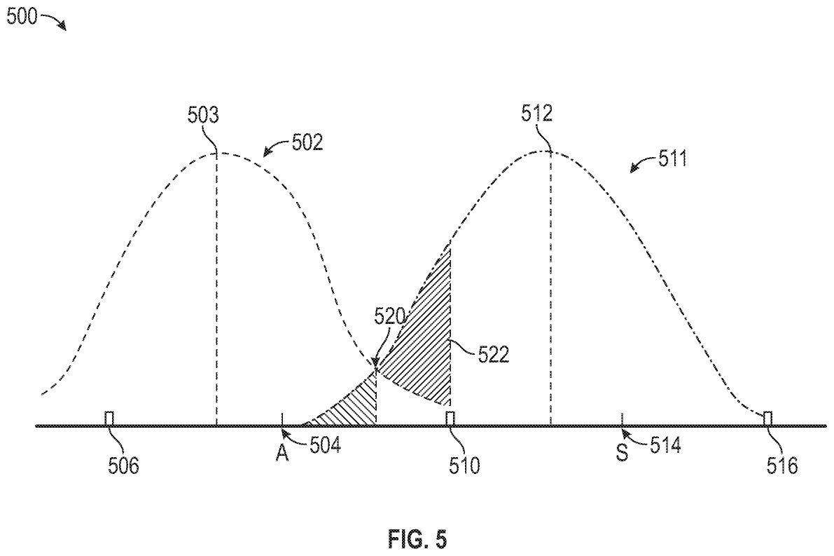

FIG. 5 shows a graphical representation 500 of the lateral spread of these two populations of keystrokes. The A population 502 is a bell-curve-shaped normal distribution representing a history of many collected keystrokes. The peak 503 is shifted left of a centerpoint 504 of the displayed A key, which is bounded on the left by border indicator 506 and on the right by border indicator 510. For the S distribution 511, peak 512 is shifted left of centerpoint 514 between boundaries 510 and 516. The distributions 502 and 511 may be separate from each other for precise and small fingered typists, but as shown and presumably more typically the overlapping tails of these distributions overlap and generate a minimum error point 520 that reflects the location of the touch map grid line to generate the least errors. Shifting the line will eliminate the errors found in area 522 above the tail of line 502, below line 511, and between the intersection 520 and the border indicator 510, at the cost of adding the much smaller area left of the border 510 and below line 511.

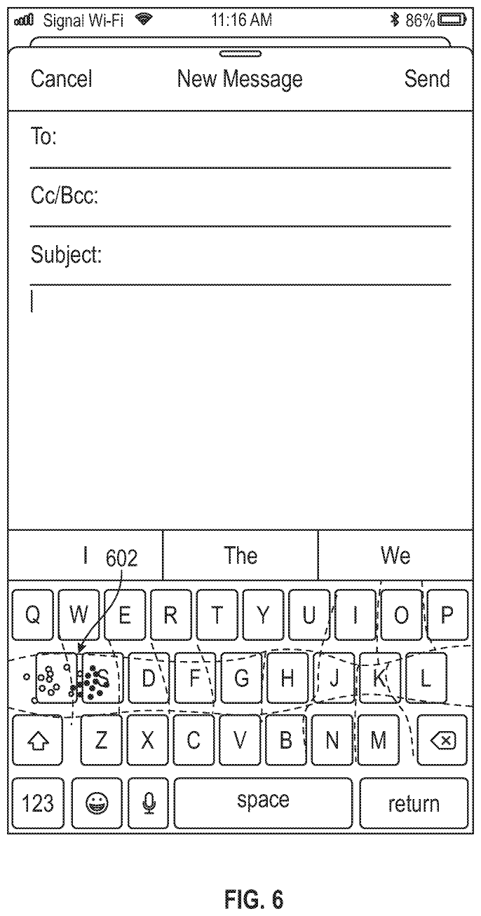

This is shown in two dimensions for illustrative purposes, but the preferred embodiment will generate a two-dimensional map placing the grid lines at the locations to minimize errors. FIG. 6 shows a display image 600 with an example of a resulting grid map 602. This shows the A and S line shifted toward the A and with an angle and a curve that reflects the data.

There are several ways to collect or generate the data from which to generate the shifted touch grid maps. A manufacturer may conduct extensive testing to determine what trends there are in broad populations to generate a default shifted map. If several “types” of users with different tendencies are found, then several default maps may be generated. Users with small fingers may have different common tendencies than users with larger fingers, for instance.

The preferred approach is to generate a customized map that is optimized for a given user. This may be created by a typing test that causes the user to type enough text to determine the initial distributions of keystroke locations for the standard keyboard. This may be effective, but requires a deliberate user involvement, and time to take the test. It also does not adjust for changes in user practices over time, requiring additional testing to reoptimize. A new device may have different characteristics, and many users will avoid the task of generating a new touch location data set from which to generate the remapped grid.

A system that bases the remapped grid on ongoing use, even potentially all the data over a significant recent period of time, can generate optimized results without the user even being aware of the process and without the time spent in a test.

During a data-gathering period (which may be ongoing) for every keystroke the system determines whether the keystroke was intended or errant. User correction such as backspace and retyping indicates an error. For example, changing “applw” to “apple” using the backspace key to erase the W followed by typing an E and proceeding shows that the “w” stroke was intended as an “e”. The location of the W stroke is put in the E distribution/population even though it was across the line. Similarly, if a user types “applw” and the autocorrect function corrects this, the system also records the same information about the error. Each keystroke location is stored along with whether or not it was an error, and if an error, the intended letter to which the stoke location should be assigned. If the auto-correct is an error and the user corrects this, it is noted. In the end, the intended letter is inferred by the final result, and the initial keystroke is assigned to that intended letter.

Some features may be used to ignore spelling errors that are identified by the system, but tolerated by the user. The system may have a bias to ignore strokes or words when in doubt, or to assume that results were intended when in doubt.

Whether in product development or in use, the system may track a score of a user's typing accuracy in order to determine whether implemented shifts of the touch grid are successful. If a change in the grid causes worse results, the system may revert to a prior more successful version.

Typing speed may also be used to generate different modes, because a user may have certain types of errors when typing fast vs. carefully. These differences may be caused by typing with two hands vs one, for instance, and have different error patterns and grid shift biases.

As shown in the right section of the keyboard of FIG. 6 in the areas of the infrequently used letters J and K, the grid may shrink in the area of unpopular characters even when there is no shift bias in the user. This is because the greater number of L uses than K uses will tend to shift the grid line toward K to minimize errors even if each is a properly centered normal distribution. This feature alone may be implemented without the user based bias, so that all devices offer a standard adjusted mode that tolerates a higher rate but lower overall instance of intended K strikes registering as L to avoid a greater number of intended L strikes that land on K. This concept may be employed in addition to the shifting bias to further provide accuracy benefits.

Changes may be offered at an option to the user with specific prompts: “You are sometimes hitting the return key when you apparently intend to select the spacebar—do you want the keyboard adjusted to help reduce these errors?”

1. A method of operating a smart device having a touch screen comprising:
displaying an array of visible key elements associated with a first pattern of key boundaries;
generating a map of touch sensitive areas associated with a second pattern of sensor boundaries not visible to a user, each corresponding to a respective one of the key elements;
detecting an error correction activity; and
based on detecting an error correction activity, modifying the map relative to the array to shift a boundary of the first pattern with respect to a boundary of the second pattern.

2. The method of claim 1 wherein the step of detecting an error correction activity includes detecting a deletion activity by the user.

3. The method of claim 1 wherein the step of detecting an error correction activity includes identifying an accidental character associated a keystroke that was in error.

4. The method of claim 3 including determining an intended character.

5. The method of claim 4 wherein determining an intended character includes identifying the character entered instead of the accidental character.

6. The method of claim 5 including storing the intended character and the accidental character as a pair record in a database.

7. The method of claim 6 including analyzing the database to identify pair records with greater than expected frequency.

8. The method of claim 7 including if a pair record has a greater than expected frequency of occurrence, and if the intended character and accidental character are adjacent in the array of key elements, then modifying the map includes moving a boundary segment between the key elements associated with the intended character and accidental character.

9. The method of claim 1 wherein the step of detecting an error correction activity includes detecting an auto-correct activity.

10. The method of claim 1 wherein the step of modifying the map includes moving a boundary segment between the key elements associated with an accidental character that is associated with the error correction activity, and a replacement character that indicates an intended character.

11. A method of operating a smart device having a touch screen comprising:
displaying a visible array of key elements;
generating a visible map of touch sensitive areas, each corresponding to respective one of the key elements;
collecting a plurality of keystrike locations; and
based on the keystrike locations modifying the map without modifying the displayed array.

12. The method of claim 11 includes determining which of the plurality of keystrike locations is intentional, and modifying the map based only on the keystrike locations that are determined to be intentional.

13. The method of claim 11 wherein the map of touch sensitive areas includes an array of resolved points, and for each of the resolved points, based on the plurality of keystrike locations, determining a most likely intended character associated with each resolved point.

14. The method of claim 13 wherein modifying the map includes setting boundaries of the touch sensitive areas to minimize errors.

15. The method of claim 11 including setting boundaries of the touch sensitive areas to locations different from the apparent boundaries between displayed key elements.

16. A smart device comprising:
a display adapted to display a keyboard displaying an array of visible elements;
a touch screen associate with the display and having an array of resolved touch points;
a processor connected to the display and to the touch screen;
a storage device connected to the processor and operable to store a map associating each of the resolved points with an associated key element;
the processor operable to associate a selected resolved point with a key element other than a key element it is registered with based on operational data collected by the touch screen.

17. The smart device of claim 16 wherein the operational data collected by the touch screen includes user errors.

18. The smart device of claim 16 wherein the operational data collected by the touch screen includes a set of touch points associated with each of a plurality of key elements.

19. The smart device of claim 16 wherein the processor is operable to determine for each resolved touch point a most probably intended key element.

20. The smart device of claim 19 wherein the processor is operable to generate a revised map and transmit it to the processor.
